(19) United States
(12) Patent Application Publication
(10) Pub. No.: US 2025/0181339 A1
(43) Pub. Date: Jun. 5, 2025

(54) AUTOMATING DEPLOYMENT OF MACHINE LEARNING WORKFLOWS USING A WORKBENCH PLATFORM

(71) Applicant: MASTERCARD INTERNATIONAL INCORPORATED, PURCHASE, NY (US)

(72) Inventors: John Zaiss, Valley Park, MO (US); Anthony Hawkins, Cottleville, MO (US); Ravishankar Rao, Lucas, TX (US)

(21) Appl. No.: 18/963,152

(22) Filed: Nov. 27, 2024

Related U.S. Application Data
(60) Provisional application No. 63/604,839, filed on Nov. 30, 2023.

(51) Int. Cl. G06F 8/61; G06N 20/00

(52) U.S. Cl. CPC G06F 8/61; G06N 20/00

(57) ABSTRACT

A computerized method configures and uses an AI/ML workbench to perform workflows. An ML project environment is automatically built on one or more server devices using an environment configuration and a node cluster is configured in the built ML project environment using a cluster configuration. The nodes of the node cluster are configured to execute workflows. Network access and connectivity to the nodes of the node cluster are provisioned using a network configuration associated with the built ML project environment. An application is deployed to the node cluster associated with an ML project workflow, whereby execution of the ML project workflow using at least one component of the one or more server devices is enabled automatically. The resulting AI/ML workbench enables automatic generation and maintenance of ML models for use with deployed applications.

### BACKGROUND

In recent years, the integration of artificial intelligence (AI) and machine learning (ML) technologies into various business processes has significantly accelerated. Data engineers and scientists are increasingly relying on comprehensive platforms that offer versatile and robust functionalities to enhance experimentation and scalable model training. The demand for such platforms arises from the necessity to manage substantial datasets, optimize computational resources effectively, and streamline collaborative efforts among multidisciplinary teams. Existing platforms often fall short in meeting the dynamic requirements of modern AI and ML applications. A critical challenge is the ability to efficiently allocate and utilize Graphics Processing Unit (GPU) resources, enabling rapid accomplishment of computational tasks without resource wastage. Additionally, scalable deployment across diverse computing environments, including virtual machines and bare metal servers, is crucial.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for configuring and using an Artificial Intelligence/Machine Learning (AI/ML) workbench to perform workflows is described. An ML project environment is automatically built on one or more server devices using an environment configuration and a node cluster is configured in the built ML project environment using a cluster configuration. The nodes of the node cluster are configured to execute workflows. Network access and connectivity to the nodes of the node cluster are provisioned using a network configuration associated with the built ML project environment. An application is deployed to the node cluster associated with an ML project workflow, whereby execution of the ML project workflow using at least one component of the one or more server devices is enabled automatically.

### BRIEF DESCRIPTION OF THE DRAWINGS

The present description will be better understood from the following detailed description read considering the accompanying drawings, wherein:

FIG. 1 is a block diagram illustrating an example system configured to provide an Artificial Intelligence (AI) workbench platform;

FIG. 2 is a diagram illustrating an example system of interactions between entities involved in a deployment of a container-based computing platform;

FIG. 3 is a diagram illustrating an example gate agent pipeline process which is used to further configure and deploy the computing platform;

FIG. 4 is another diagram illustrating an example gate agent pipeline;

FIG. 5 is a flowchart illustrating an example method performed by a TSA job, such as the TSA jobs described above at least with respect to FIGS. 3 and 4;

FIG. 6 is a flowchart illustrating an example method performed by a Taxi job, such as the Taxi jobs described above at least with respect to FIGS. 3 and 4;

FIG. 7 is a diagram illustrating an example cluster pipeline;

FIG. 8 is a flowchart illustrating an example process for refreshing certificates;

FIG. 9 is a flowchart illustrating an example process for management of Internet Protocol (IP) addresses in a pipeline;

FIG. 10 is a diagram illustrating an example end-to-end ML Operations framework that highlights the parts of the framework that are offered and/or performed by the described AI workbench; and

FIG. 11 illustrates an example computing apparatus as a functional block diagram.

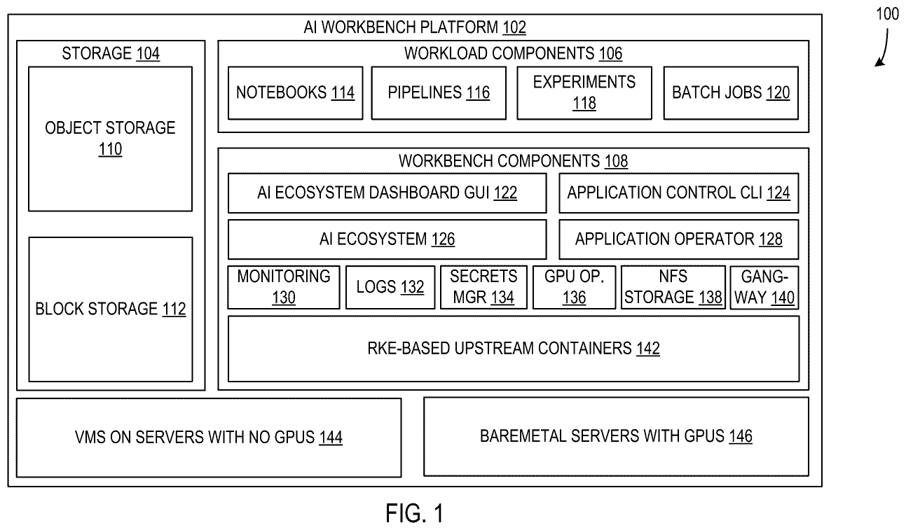

Corresponding reference characters indicate corresponding parts throughout the drawings. In FIGS. 1 to 11, the systems are illustrated as schematic drawings. The drawings may not be to scale. Any of the figures may be combined into a single example or embodiment.

### DETAILED DESCRIPTION

The disclosure describes an artificial intelligence (AI)/machine learning (ML) workbench. This workbench is configured to empower data engineers and scientists with a rapid experimentation space utilizing tools such as JUPYTER notebooks, coupled with fine-tuned NVIDIA MIG profiles for efficient resource utilization. Further, the workbench enables efficient and scalable ML model training through dynamic Graphics Processing Unit (GPU) allocation, specialized GPU cluster environments, and centralized collaboration features. The workbench offers the capability to seamlessly register, manage, and share features, fostering collaborative feature engineering. Additionally, the workbench provides an environment tailored for large-scale training and experimentation, promoting faster model development cycles.

In some examples, the workbench uses ML workflow deployment tools (e.g., KUBEFLOW) to make use of hybrid elastic compute resources and to enable workload segregation (e.g., horizontal vs vertical compute as a service segregation) that is useful for distinguishing Extract, Transform, Load (ETL) pipelines vs ML pipelines. In some such examples, the workbench provides a dedicated ecosystem for pure AI/ML workloads, methods for workflow instantiation that enables workflow-based AI product development, and even provide a serving ecosystem that can render complex models in auth route through a data management platform (DMP) within 20-30 milliseconds.

Further, in some examples, the described workbench is configured to use virtualized GPUs (VGPUs), which provide the following benefits. VGPUs have reduced provisioning time when compared to bare metal machines. VGPUs enable flexible deployment strategies and increased resilience. VGPUs enable simplified deployments and improved development and maintenance processes.

In an exemplary operation of the disclosed artificial intelligence (AI) and machine learning (ML) workbench platform, the system activates its components to perform scalable model training and deployment. The process initiates with data engineers importing raw datasets into the system's data processing pipeline. This pipeline utilizes real-time (RT) and non-real-time (NRT) data feeds to undertake data collection, followed by preprocessing tasks that cleanse and format the data. Subsequently, feature engineering modules transform preprocessed data into extracted features.

Upon producing extracted features, the system registers these in both an online and offline feature store. The online feature store supports real-time retrieval of features necessary for immediate model training, while the offline store accommodates features that are accessed periodically for batch processing tasks. In some examples, the system's model development process utilizes JUPYTER notebooks optimized through NVIDIA Multi-Instance GPU (MIG) profiles that efficiently allocate and manage GPU resources. This allows data scientists to conduct experiments and scale up model training within a specialized GPU cluster environment, differentiated into virtual machines, virtual computing instances, and bare metal servers with GPU capabilities.

Once models are developed, they are subjected to training and tuning stages, where the system dynamically allocates GPU resources from the centralized pool enabled by the platform's dynamic GPU allocation mechanism. Trained models are then registered in the platform's model registry for subsequent deployment. For deployment, in some examples, the AI workbench utilizes KUBEFLOW and its ML workflow management capabilities to segregate workloads effectively among available resources. This is facilitated by the hybrid elastic compute resource management, which optimizes the use of both virtualized and physical resources when compared to other AI workflow solutions.

Model deployment involves the automatic setup of inference endpoints within a node cluster built using the platform's container-based deployment system, powered by KUBERNETES containers. This setup incorporates necessary runtime environments, ensuring models are quickly operationalized across distributed computing devices with configured network access and connectivity. Additionally, the platform includes a monitoring system and logging processes to track model performance post-deployment, while access control mechanisms maintain secure operations. The system's robust communication network supports data exchange and task execution across the computing infrastructure. Thus, the efficiency of the use of system resources is increased and the user effort/time required for monitoring model performance is reduced.

Finally, through Network as a Service (NaaS) integration performed by the gate agent, the workbench configures and manages network resources using YAML Ain't Markup Language (YAML)-defined documents, ensuring continuous connectivity and optimal performance of AI/ML tasks. The described operation illustrates the platform's capability to seamlessly facilitate end-to-end ML operations, from data processing and feature engineering to model training, deployment, and monitoring, thereby enhancing the lifecycle management of AI/ML models.

Aspects of the disclosure describe the combination of elements of automatically building an ML project environment on a server device using an environment configuration, configuring a node cluster in the built ML project environment using a cluster configuration, provisioning network access and connectivity to nodes of the node cluster using a network configuration associated with the built ML project environment, and deploying an application on the node cluster associated with an ML project workflow, whereby the ML project workflow is executed using at least one component of the server device automatically. Thus, these aspects of the disclosure are directed to a particular improvement by automatically configuring and deploying an ML project environment and an associated AI workbench application. Specifically, the described methods limit execution of the deployed application to the automatically built ML project environment and the associated node cluster. The method can be used to automatically build ML project environments and to configure associated node clusters with reduced manual effort and improved efficiency of system resources. This provides a specific improvement over prior systems, resulting in flexible creation of ML project environments and improved AI/ML model generation and use.

FIG. 1 is a block diagram illustrating a system 100 configured to provide an Artificial Intelligence (AI) workbench platform 102. The system includes an object storage component 110 and block storage component 112 (e.g., RED HAT CEPH) in storage 104. Further, the system 100 includes workload components 106, including elements and/or entities associated with notebooks 114, machine learning (ML) workflow pipelines 116 (e.g., KUBEFLOW), and experiments 118 associated with the enabled AI operations. The system 100 enables the storage of and/or execution of batch jobs 120 (e.g., APACHE SPARK batch processing).

Further, in some examples, the system 100 includes workbench components 108, which include an AI ecosystem dashboard graphical user interface 122 (GUI) configured to enable the management of ML workflow pipelines 116 of the system 100. Additionally, or alternatively, the system includes an application control command line interface 124 (CLI) that enables the control and/or management of the batch jobs 120 of the system 100.

It should be understood that, in some examples, the system 100 of FIG. 1 is configured to use container orchestration in its operation (e.g., KUBERNETES (K8S)). Other types of containers can also be used without departing from the description. In some such examples, the various entities of the system are created and operate as one or more containers within the container framework of the system.

In some examples, the system 100 includes containers or other entities (e.g., AI ecosystems 126 such as KUBEFLOW and/or application operators 128 such as SPARK Operator) for performing the workflows of the ML workflow pipelines 116 and/or the batch jobs 120 of the system. Further, in some such examples, the performance of those workflows is supported by or otherwise enabled through the use of monitoring processes 130, logging processes 132, a secrets manager 134 (e.g., an entity that manages secrets such as user credentials), operator processes 136 that enable the use of graphics processing units (GPUs) for performance of the workflows, a defined network file system (NFS) storage class 138, access control processes, front-end support interface processes (e.g., GANGWAY 140 to support authentication to an Identity Provider integrated with an OpenID Connect (OIDC)), and RKE-based upstream container orchestration 142.

In some examples, these entities of the system are located and/or executed on one or more virtual machines 144 (VMs) or other virtual computing instances (VCIs). Additionally, or alternatively, the entities of the system are located on and/or executed on hardware computing devices such as bare metal server devices that include GPUs 146 for performing the processing operations.

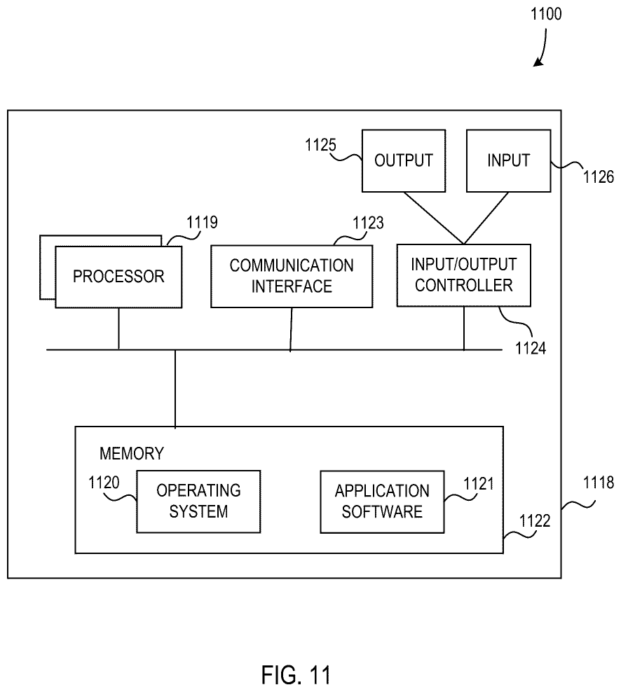

Further, in some examples, the described systems include one or more computing devices (e.g., the computing apparatus of FIG. 11) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, a first VCI is executed on a first computing device and a second VCI is located on a second computing device within the system 100. The first computing device and second computing device are configured to communicate with each other via network connections. Alternatively, in some examples, other components of the ML workflow pipeline section (e.g., monitoring processes and logging processes) are executed on separate computing devices and those separate computing devices are configured to communicate with each other via network connections during the operation of the ML workflow pipeline section. In other examples, other organizations of computing devices are used to implement system 100 without departing from the description.

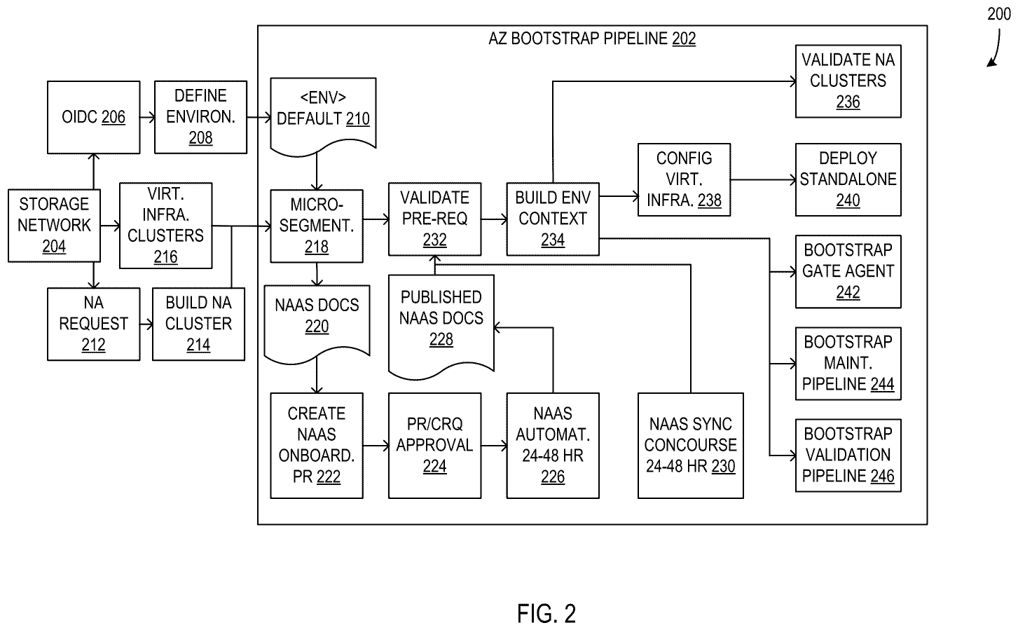

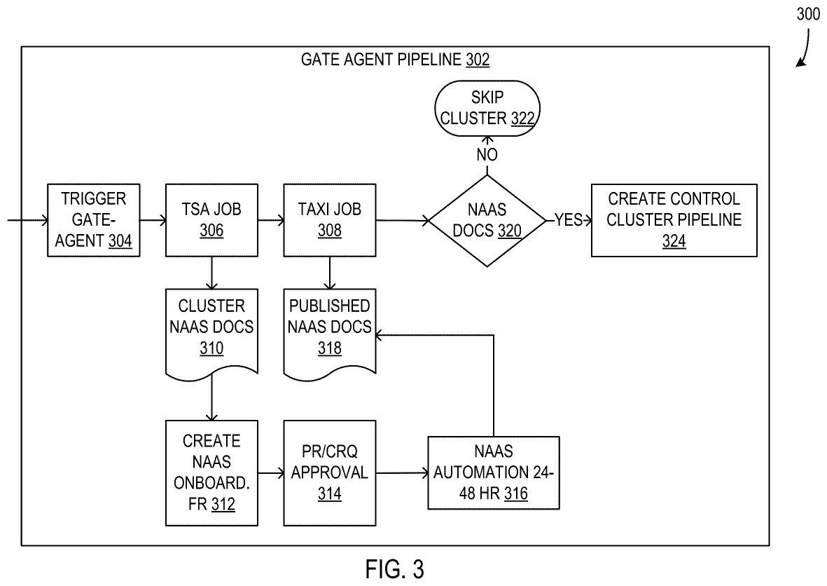

FIG. 2 is a diagram illustrating a system 200 of interactions between entities involved in a deployment of a container-based computing platform. In some examples, the system is used to automatically deploy a KUBERNETES platform to a site at which the hardware configuration is known. For instance, in an example, a computing platform deployment process is initiated by providing the location to which the computing platform will be deployed and the hardware configuration present at that location. The described systems and methods are configured to use the information about the hardware configuration and information about the specific configuration of the computing platform to be deployed and automatically perform the deployment as described herein, at least with respect to FIGS. 2 and 3.

In some examples, the system includes a validation of the requirements for the deployment. For instance, after the deployment process has been initiated, the process includes validating that the requirements or prerequisites for the deployment are present and, if they are not present, the deployment does not proceed. Once the requirements of the deployment are validated, the deployment automatically proceeds. In this way, the described systems and methods enable the deployment of the computing system to be efficiently initiated as soon as the underlying infrastructure is ready for the deployment. This feature provides a technological advantage of enabling the building and deployment of the system to begin as soon as possible.

It should be understood that, in some examples, the described systems and methods use a codebase that defines the building and deployment of the described environment using pluggable components that are compatible with nearly any site to which the environment is deployed. The described systems and methods are sufficiently automatic to fully deploy the environment and configure it for operation with minimal user interaction after the initial configuration information is provided.

On the left side of FIG. 2, the pre-bootstrapping operations are performed by the illustrated entities (e.g., the Availability Zone (AZ) bootstrap pipeline 202). The storage network 204 (e.g., a Virtual Storage Area Network (vSAN)) operates to get one or more networks assigned to the storage pod(s) in the AZ. From this network 204, the OpenID Connect (OIDC) component 206 and the virtual infrastructure cluster(s) 216 (e.g., K8S vSphere clusters) are configured and initialized, wherein the OIDC component 206 is configured to enable sign-ons and/or other authentication processes on the system being deployed and the virtual infrastructure clusters 216 are groups of host computing devices upon which many of the other entities of the systems described herein are located and/or executed. The virtual infrastructure clusters 216 represents a separate automated process that is external to the illustrated workflow. Further, in some examples, the validate-pre-req process runs in a continuous loop checking to ensure that all the prerequisites are in place, including confirming the availability of the virtual infrastructure clusters 216 for compute resources.

Further, in some examples, the process includes an internet protocol (IP) request 212 to have the network appliance cluster built at 214, wherein this cluster is configured to enable load balancing of network traffic between multiple services offered by the deployed computing platform.

Once these pre-bootstrapping entities are in place, an environment definition 208 (e.g., a K8S Environment definition) is provided for use during the AZ Bootstrap Pipeline (e.g., as <env> default.yml 210), during which elements of the system are configured and deployed. In some examples, once the network addressing is obtained and all dependent services are available in the AZ, the environment configuration is added to the k8s-cluster-environment repository or another similar repository such that the environment definition information is stored in multiple places.

In some examples, once all the pre-bootstrapping activities are complete, the AZ bootstrap pipeline 202 is created (e.g., using a pipeline.py module).

In some examples, the AZ Bootstrap Pipeline includes an env-micro-segmentation job 218 that is configured to prepare Network as a Service (NaaS) documents 220 for use in the environment. Further, in some examples, the env-micro-segmentation job 218 uses a default.yml file 210 or files associated with default environment configuration information during this process. Additionally, or alternatively, in some examples, the inputs to the env-micro-segmentation job 218 include the default.yml file 210 associated with the default environment configuration and the env.py file associated with configuring an AZ for the KUBERNETES system. In some such examples, the outputs include a YAML file associated with the specific environment configuration (e.g., <env>-k8s-bastion.yaml) and/or a branch in the fork-network-docs-prod repository with NaaS documents 220 that are specific to the environment.

Further, in some examples, after the NaaS documents 220 are automatically generated, those documents are used by users to create pull requests (PRs) 222 and/or change requests (CRQs) associated with the clusters of the system being deployed. A PR is a way of proposing changes to code in a repository and requesting feedback from other contributors. A CRQ is a process for requesting, reviewing, approving, and/or implementing changes to a cluster in the system (e.g., PR/CRQ approval 224). Thus, these steps enable users to review and suggest changes for the default configuration of the computing platform that is being deployed. Additionally, or alternatively, in some examples, some PRs and/or CRQs are generated automatically during the deployment process described herein. All PRs and CRQs, whether manually created or automatically generated, a subject to approval by teams of users associated with the NaaS system and/or security thereof.

In some examples, after the approval of PRs and CRQs, NaaS automation processes 226 are performed. In some such examples, such processes take 24-48 hours to complete, although in other examples, the processes are completed in faster or slower times without departing from the description. NaaS Automation 226 is used to simplify and streamline the deployment process and/or the operations of the deployed computing platform by providing network capabilities on demand to the various clusters of the platform. It should be understood that NaaS is an internally maintained declarative system where network connectivity is described in YAML documents. The NaaS system then configures the network endpoints (e.g., physical firewalls or software defined firewalls) to enable connectivity using micro-segmentation.

In some examples, the NaaS sync concourse 230 step is performed to cover any access needed that is not covered by NaaS (e.g., access into the AZ for Concourse). In other examples, this step is unnecessary without departing from the description. In most examples, NaaS does not cover 100% of the connectivity automation for the environment. In the case where alternative methods are needed to enable connectivity, the NaaS sync job is used.

After NaaS automation, the NaaS documents are published (e.g., as published NaaS docs 228) and the AZ Bootstrap Pipeline processes proceed. The validate-pre-req job 232 process is triggered when the NaaS documents of the environment are published. The process validates the prerequisites of the remaining pipeline processes and, if they are validated, the process proceeds to the build-env-context process 234, which builds the environment context and enables all the remaining processes of the AZ Bootstrap Pipeline. For instance, in an example, the build-env-context process 234 creates the manifests used to manage and configure container-based storage pods in an AZ. Further, in some such examples, the input of the build-env-context process 234 includes a bootstrap-config yaml file updated for the environment, a pipeline.py file updated for the environment, an env.py module for configuring an AZ for the container platform, the default.yml file associated with the default environment configuration, an ipam.py module for managing IP addressing for containers in the AZ based on pods (e.g., vsphere-vsan pods), and/or a vault_secret_setup.py module configured to dynamically create secrets for the environment. Additionally, the output of the build-env-context process 234 includes an ipam.yaml file configured as a manifest used for allocating IP addresses to nodes and load balancers, environment secrets (e.g., information associated with entity authentication), and/or S3 buckets defined in default.yml along with the one for the environment.

Additionally, or alternatively, in some examples, the validate-pre-req job 232 has inputs including the default.yml file associated with the default environment configuration and/or a connectivity. py file used to evaluate connectivity locally and/or through a remote host. The output of the validate-pre-req job 232 is a pass/fail binary value indicating whether the prerequisites are validated.

In some examples, the remaining processes of the AZ Bootstrap Pipeline include a configure virtual infrastructure process 238 which in turn causes a deploy-standalone process 240 to execute. Further, the processes include a validate network appliance clusters process 236, a bootstrap gate-agent process 242, a bootstrap maintenance pipeline process 244, and/or a bootstrap validation pipeline process 246. In some such examples, the bootstrap gate-agent process 242 causes the configuration and generation of a gate agent which is described in greater detail below. Further, in some examples, the bootstrap maintenance pipeline process 244 and bootstrap validation pipeline process 246 configure and cause a maintenance pipeline process and a validation pipeline process to be executed, respectively. It should be understood that these steps of the process include the KUBERNETES-specific configuration being added to the virtual infrastructure environment built for the KUBERNETES platform. For example, folders are created to organize virtual machines and operating system templates are copied over. In other examples, other types of configuration are used without departing from the description.

In some examples, the bootstrap-gate-agent process 242 includes inputs of the default.yml file and a gate-agent-az.py module designed to create cluster pipelines in the AZ. The output of the bootstrap-gate-agent includes a gate agent pipeline for the environment and/or branches for clusters in the fork-network-docs-prod with associated NaaS documents.

In some examples, the validate network appliance clusters process 236 includes input of the default.yml file and an f5-vserver.py python module for interacting with F5 clusters for the container platform. The output is a pass/fail value based on whether the validation was successful.

Further, in some examples, the configure virtual infrastructure job 238 is used to validate access to VCENTER, confirm that a template associated with the deployment process is present, and/or set up the vSphere folder structure if it is not already present. In some such examples, input to the configure-vsphere job includes the default.yml file and a vsphere-az.py module designed to handle all vSphere interactions for the AZ. The output includes the resulting configuration of the vSphere components such that they are ready for the deployment of the container platform.

In some examples, the deploy-standalone job 240 is used to deploy all standalone VMs and/or VCIs that are necessary for configuration of the environment. A standalone VCI is defined as any VCI in the storage pod that is not a node of the container platform. For instance, in an example, the standalone VCIs include a bastion host. In some such examples, tasks of the deploy-standalone job include on-demand creation of the tfvars needed for each VCI, deploying the VCIs, and/or adding tools and/or apps to the standalone host as required. Further, in some such examples, inputs to the deploy-standalone job include the default.yml file, a vsphere-az.py module configured to handle all virtual infrastructure interactions for an AZ, a Terraform model for standalone, and/or an env.py module for configuring the AZ for the container platform.

Additionally, or alternatively, in some examples, the AZ Bootstrap Pipeline includes a validate-env job that performs the final step before bootstrapping the gate agent for the environment. The validate-env job performs outbound node connectivity tests. In some such examples, the input of the validate-env job includes the default.yml file and/or a connectivity.py module used to test the connectivity locally and through a remote host. The output is a pass/fail value depending on the success of the connectivity validation.

FIG. 3 is a diagram 300 illustrating a gate agent pipeline process 302 which is used to further configure and deploy the computing platform. Once the AZ Bootstrap Pipeline jobs are complete, the gate agent is bootstrapped as described above. The trigger-gate-agent process 304 is triggered once the bootstrap process is complete and TSA job(s) 306 and/or Taxi job(s) 308 are initiated by the gate agent process.

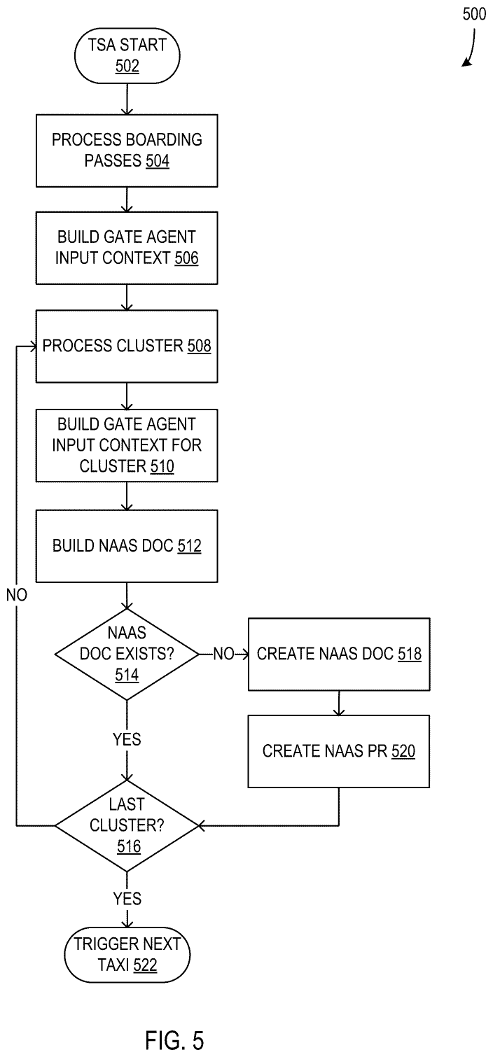

In some examples, the TSA job 306 assigns IP addresses and creates the NaaS documents 310 and cluster input files for each cluster (e.g., in a YAML file called boarding_pass.yml) for the environment. Additionally, or alternatively, in some examples, the TSA job generates a branch in the fork-network-docs-prod for each cluster and/or pushes the NaaS documents to the autogenerated cluster branch. Other features of a TSA job are described below with respect to FIG. 5.

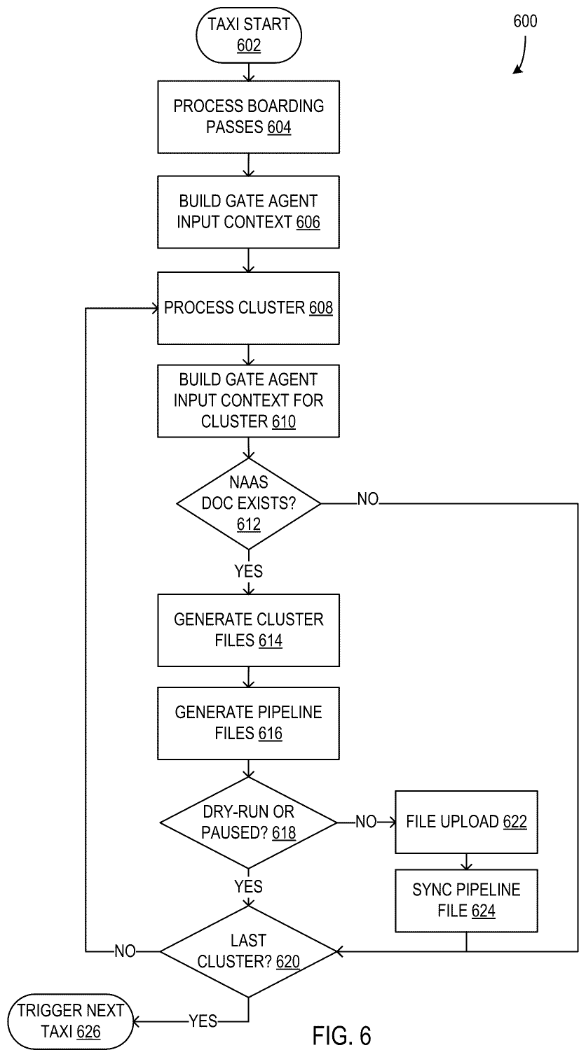

Further, in some examples, a Taxi job 308 creates and/or synchronizes each cluster pipeline defined for the environment. If NaaS documents are not published for a cluster (e.g., published NaaS documents 318), the Taxi job skips the cluster. Other features of a Taxi job are described below with respect to FIG. 6.

In some examples, the creation of onboarding PR 312, PR/CRQ approval 314, and NaaS automation 316 processes are the same as defined in the AZ Bootstrap Pipeline. Once a NaaS document 310 is published for a cluster, the gate agent is triggered by the change in the network-prod-docs repository. The gate agent builds in the cluster and the cluster pipeline triggers upon creation and deploys the cluster without any further human interaction.

In some examples, application NaaS documents 310 are generated for each tenant and/or code deployment application that cover both coarse-and fine-grained NaaS policies. If a cluster does not have NaaS documents at 320, the gate agent skips the cluster at 322. Alternatively, if a cluster has NaaS documents at 320, a control cluster pipeline of the cluster is created at 324. Any location that the container management system (e.g., KUBERNETES app) is exposed to through its components is also exposed to both the load balancing modules of the system and cluster nodes to which it corresponds. (e.g., deployment scope: worker=ingress Load Balancing (LB) and worker nodes). Additionally, or alternatively, an app-name field is configured to match the deployment application label as it is deployed in the container system so that it can be interacted with properly. The corresponding components are made available in the cluster document specified in the cluster field of that document. For example, if ‘deployment-scope: worker’ is set, then the worker nodes are configured to have an “ingress-access-worker” component with a port and the ingress load balancer is configured with the name “ingress-f5-ve”. In another example, if “deployment-scope:control-plane” is set, then the control-plane nodes have an “api-access-control” component configured with a port and the Application Programming Interface (API) load balancer is configured with the name “k8s-api-f5-ve”.

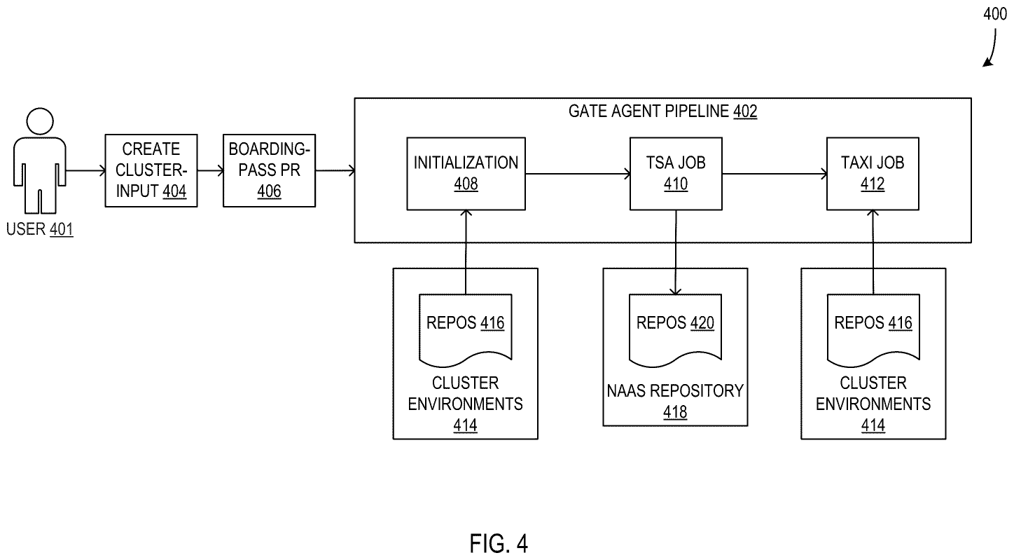

FIG. 4 is another diagram 400 illustrating a gate agent pipeline 402. In some examples, a user 401 provides input 404 for creating clusters and pull requests 406 associated therewith are sent to the gate agent pipeline 402. An initialization job 408 of the gate agent pipeline obtains data from a repository 416 of data associated with the cluster environments 414 using the pull requests. The obtained data is provided to a TSA job 410, which validates the boarding-pass file, builds the NaaS documents for the clusters, and/or creates a PR to onboard the clusters to NaaS. Those generated documents and associated information are stored in a repository 420 associated with NaaS repositories 418.

Then, a Taxi job 412 is executed to validate the boarding-pass file, build the RANCHER KUBERNETES engine (RKE), terraform, and deployments documents for the clusters. Further, the Taxi job 412 is configured to perform operations for new clusters. In some such examples, the new cluster operations include validating the cluster-input file, creating a branch in the environments repository 416 of the cluster environments 414 for the cluster, and/or validating the NaaS documents for the cluster (e.g., documents generated by the TSA job). If the validation passes, a new pipeline is created for the cluster and, if the validation fails, the pipeline creation is skipped. For an existing cluster, the Taxi job 412 sets resources in the pipeline to be controlled by a main branch of a version control repository (e.g., BITBUCKET resources).

Further, in some examples, the gate agent pipeline 402 includes pushing changes, if any, to the cluster branches of the clusters in the environments repository.

FIG. 5 is a flowchart illustrating a method 500 performed by a TSA job, such as the TSA jobs 306 and/or 410 described above at least with respect to FIGS. 3 and 4.

The TSA job starts at 502 and processes boarding passes at 504 (e.g., data of clusters that will be onboarded based on the operations of the TSA job and/or its associated gate agent entity). The gate agent input context is built at 506, and the TSA job begins to process each of the clusters to be onboarded at 508 based on the processed boarding passes.

The TSA job processes a cluster at 508, builds gate agent input context for that cluster at 510, and then builds NaaS documents for that cluster at 512. The TSA job validates the NaaS documents and, if they exist at 514, the process proceeds to the last cluster check at 516. Alternatively, if the NaaS documents do not exist at 514, the process proceeds to create the NaaS document(s) at 518, create the NaaS PR at 520, and then the process proceeds to the last cluster check at 516.

At the last cluster check, if the cluster that was just processed is the last cluster at 516, the process proceeds to trigger the next Taxi job at 522. Alternatively, if the cluster that was just process is not the last cluster at 516 the process returns to process the next cluster at 508.

FIG. 6 is a flowchart illustrating a method 600 performed by a Taxi job, such as the Taxi jobs 308 and/or 412 described above at least with respect to FIGS. 3 and 4.

The Taxi job starts at 602 and processes the boarding passes at 604 as described above with respect to the TSA job. Gate agent input contexts are built at 606, and the processing of the clusters begins at 608.

A cluster is processed at 608, and a gate agent input context is built for that cluster at 610. If NaaS documents exist for the cluster at 612, the process proceeds to generate cluster files associated with the cluster at 614. Alternatively, if NaaS documents for the cluster do not exist at 612, the rest of the processing of the cluster is skipped and the process proceeds to the last cluster check at 620.

If NaaS document(s) do exist for the cluster, cluster files are generated at 614 and associated pipeline files are generated at 616 for the cluster. If this operation is considered a dry run or is paused at 618, the process proceeds to the last cluster check at 620. Alternatively, if the operation is not considered a dry run and is not paused at 618, the process proceeds to performing an upload of the generated files at 622 and the pipeline file is synchronized at 624. Then the process proceeds to the last cluster check 620.

At the last cluster check, if the cluster that was just processed is the last cluster in the set of clusters to be processed at 620, the process proceeds to trigger the next taxi job at 626. Alternatively, if the cluster that was just processed is not the last cluster at 620, the process returns to process the next cluster in the set of clusters to be processed at 608.

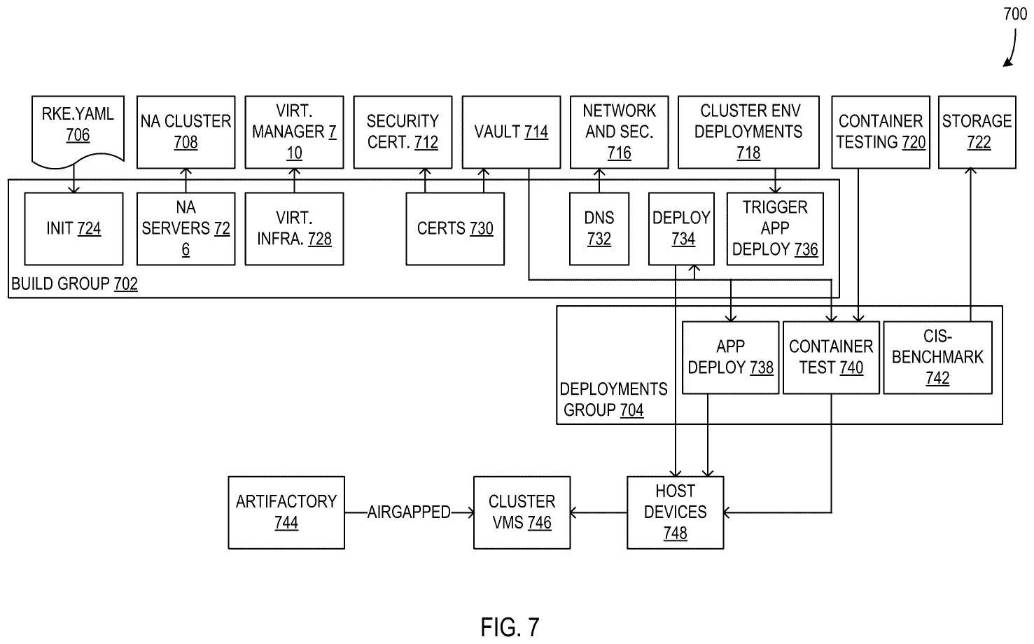

FIG. 7 is a diagram illustrating a cluster pipeline 700. In some examples, this cluster pipeline 700 is used as part of or in conjunction with a system such as the system 100 of FIG. 1 and/or with platform pipelines such as the pipeline 202 of FIG. 2.

A build group 702 of entities are initialized at 724 (e.g., using a rke.yaml file 706). In some examples, the entities include an f5-vservers entity 726, a virtual infrastructure entity 728, certificates or certs entities 730, a Domain Name Service (DNS) entity 732 configured to create DNS records, a deployment entity 734 associated with containers (e.g., deploy-k8s), and a trigger-app-deployment entity 736.

In some examples, the f5-vservers entity 726 enables an network appliance cluster 708, the virtual infrastructure entity 728 enables a virtualization manager entity 710 of the cluster, the certs entities 730 are used by a security certificate entity 712 (e.g., a VENAFI entity) and/or a vault entity 714, and the DNS entity 732 enables a networking and security entity 716 (e.g., an INFOBLOX entity). Further, in some such examples the vault entity 714 that uses the certs entities 730 is used by or otherwise enables the operation of the deployment entity and some entities of a deployment group 704 of entities, described below, such as the app-deployment entity 738 and/or a container-based testing entity 740 (e.g., k8s-terratest).

Further, in some examples, the cluster pipeline includes a deployments group 704 of entities, including an application deployment entity 738 (e.g., app-deployment), a container-based testing entity 740 (e.g., k8s-terratest), and/or a benchmark entity 742 (e.g., cis-benchmark).

The cluster pipeline configures and deploys a cluster of Virtual Machines (VMs) or other VCIs through one or more host devices 748 (e.g., a bastion host). In some examples, the cluster pipeline uses the container-based deployment entity 734, the application deployment entity 738, and/or the container-based testing entity 740 to deploy and test the VMs 746, enabling the cluster to be created and operated efficiently. For instance, in an example, the various entities of the pipeline are enabled to use a secure shell (SSH) protocol to access the VCIs through the host devices as illustrated.

In some examples, the illustrated cluster pipeline is a build pipeline and other types of pipelines are also used. For instance, in some examples, other pipelines include deployments pipelines, nuke pipelines, upgrade pipelines, test pipelines, manual pipelines, and/or scheduled pipelines.

In some examples, the processes of the illustrated pipeline include a resource triggering the initialization process (e.g., init) of the pipeline when the rke.yml file is updated. Alternatively, or additionally, other changes to an associated repository can trigger the init process.

In some such examples, the f5-vservers job is triggered by the init job posting trigger-next after completion. The f5-vservers job creates servers for API and Ingress for the cluster. In some examples, a custom module is used to connect the admin interface from Concourse to create the servers for the cluster.

In some examples, the virtual infrastructure job builds VMs using virtual infrastructure tools (e.g., using a Terraform model). The virtual infrastructure job is built from Centos templates that have been adjusted to work with container-based clusters. The sizing of the built VMs is defined by role, control plane or worker node, as defined in the cluster input file (e.g., cluster-input.yaml). Examples of cluster-input.yaml files are provided below in Appendices D and E.

In some examples, the certs job includes using RKE to generate certificate signing requests (CSRs). Certificates are issued by a security certificate entity or other similar entity and are stored in the vault.

In some examples, the DNS job includes updating DNS entries in an INFOBLOX entity or other similar entity.

In some examples, the deployment job, or deploy-k8s job, includes deploying KUBERNETES using the deployer software. Further, in some examples, the container artifacts used by the deployment process are air-gapped via ARTIFACTORY 744 or another similar tool or entity.

In some examples, the trigger-app-deployment job 736 includes triggering the application deployment job 738. The trigger-app-deployment job 736 is triggered by the deploy job 734 posting trigger-next after completion and/or otherwise from the watch-cluster-config resource.

Further, in some examples, examples, the app-deployment job 738 of the deployments group 704 is triggered by the trigger-app-deployment job 736 and is configured to deploy all applications to the cluster (e.g., using HELM).

In some examples, the container test job 740 of the deployments group 704 is triggered by the app-deployments job 738 posting trigger-next after completion and/or by the K8S testing entity 720 and is configured to use TERRATEST or other testing entity to validate that deployments are healthy and function as expected.

In some examples, the cis-benchmark job 742 is triggered by the container test job 740 posting trigger-next after completion and is configured to use the Center for Internet Security (CIS) Operator framework to benchmark the posture of the cluster and store results in S3 722.

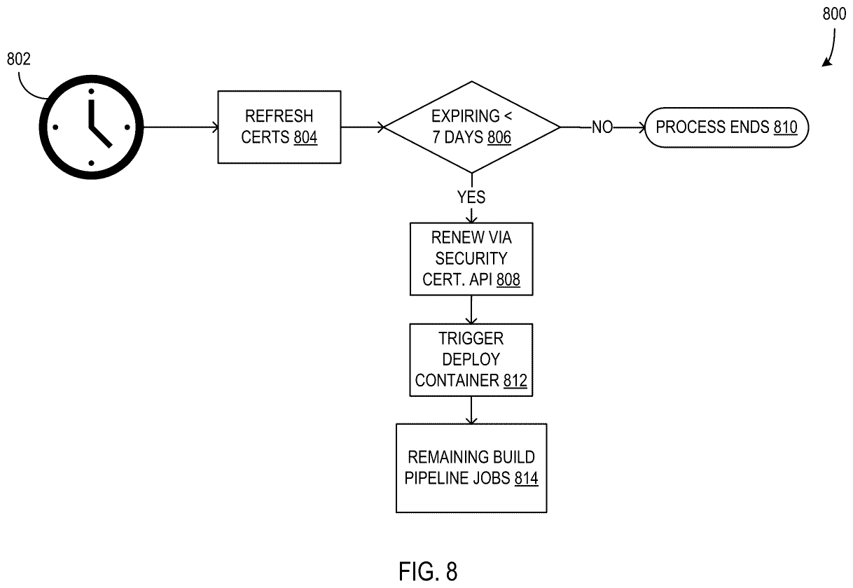

FIG. 8 is a flowchart illustrating a process 800 for refreshing certificates. In some examples, this process 802 is performed as part of a pipeline associated with a cluster deployment as described herein.

In some examples, periodically, the illustrated process is executed at 802. The certificates are refreshed at 804 and, if a certificate is expiring within a defined time period at 806 (e.g., less than seven days), the process proceeds to renewing the expiring certificate at 808 (e.g., using a security certificate API). Then, the process triggers the deploy container job at 812 and proceeds with the remaining build pipeline jobs at 814. Alternatively, if a certificate is not expiring within the defined time period at 806, the process ends at 810.

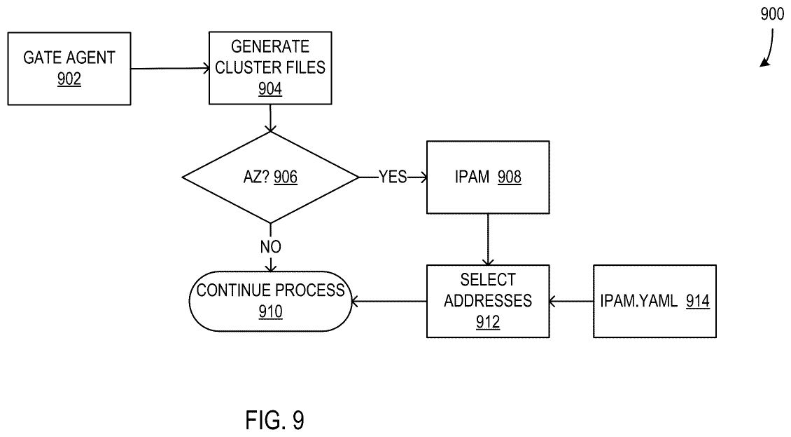

FIG. 9 is a flowchart illustrating a process 900 for management of IP addresses in a pipeline as described herein. In some examples, a gate agent job 902 generates cluster files at 904 during its operations. If those cluster files are associated with an AZ at 906, an IP address management (IPAM) job or entity 908 is executed. Addresses are selected at 912 using an ipam.yaml file 914 and then the pipeline processes continue to operate as normal at 910. Alternatively, if the cluster files are not associated with an AZ at 906, the process continues to operate as normal at 910. Example ipam.yaml files are included below in Appendices A, B, and C. Appendix A is an initial ipam.yaml file. Appendix B is an ipam.yaml file after the clusters are defined. Appendix C is an ipam.yaml file after one deployment has occurred.

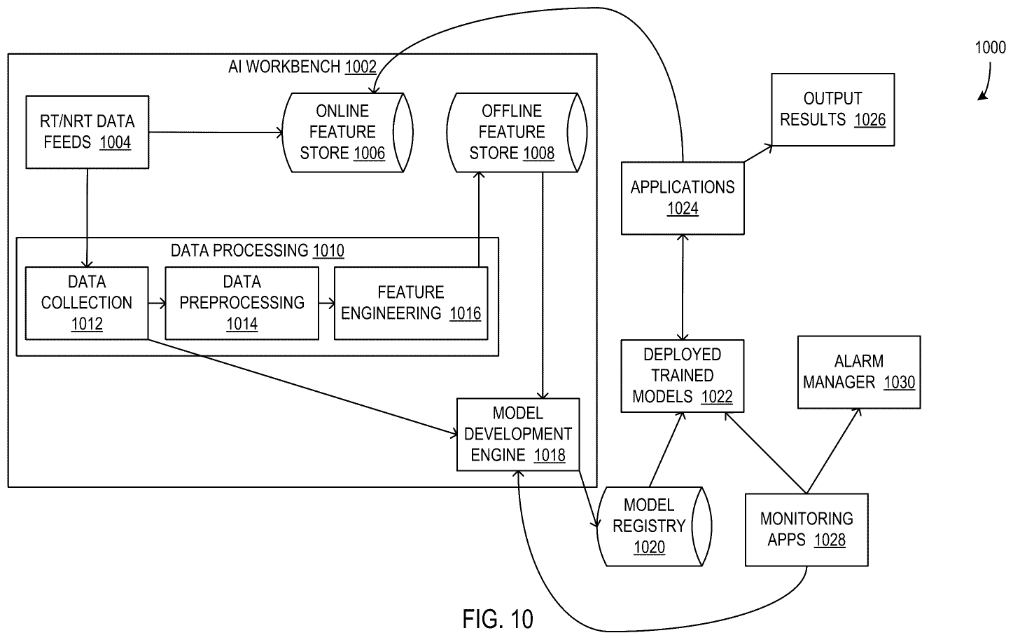

FIG. 10 is a diagram illustrating an end-to-end ML Operations framework 1000 that highlights the parts of the framework that are offered and/or performed by the described AI workbench 1002. In some examples, the AI workbench 1002 provides data processing 1010, model development (e.g., the model development engine 1018), and/or feature storage (e.g., the online feature storage 1006 and offline feature store 1008) as illustrated in FIG. 10 and as described herein.

The AI workbench 1002 contains a data processing 1010 pipeline comprising of data collection 1012, data preprocessing 1014, and feature engineering 1016 modules. Data collection gathers raw data from RT/NRT data feeds 1004, which is subsequently processed and transformed into extracted features, wherein the extracted features are provided to the offline feature store 1008 for storage. These features are utilized by feature engineering 1016 to produce generated features that are fed into the offline feature store 1008.

The online feature store 1006 facilitates the storage of data from the RT/NRT data feeds 1004 and/or the applications 1024, whereas the offline feature store 1008 enables the immediate retrieval of real-time features for model development using the model development engine 1018 and the storage of features for periodic access. Both these stores serve as repositories, from which generated features are fetched for subsequent model development. In the model development engine 1018, models are developed, trained, and tuned using the supplied features. Upon completion, trained models are transferred to the model deployment section, where they are registered and/or stored in a model registry 1020.

Model deployment is responsible for deploying trained models 1022 on the requisite platforms. Deploying trained models 1022 is an operational function that establishes inference endpoints, enabling real-time model evaluation. The model deployment is closely monitored by model monitoring which utilizes monitoring apps 1028 to detect anomalies.

Detected anomalies trigger the notification system, which comprises an alarm manager 1030 responsible for alert management. Applications utilize deployed models 1022 with other applications 1024 to produce output results 1026, completing the cycle of the ML-Ops lifecycle.

### Exemplary Operating Environment

The present disclosure is operable with a computing apparatus according to an embodiment as a functional block diagram 1100 in FIG. 11. In an example, components of a computing apparatus 1118 are implemented as a part of an electronic device according to one or more embodiments described in this specification. The computing apparatus 1118 comprises one or more processors 1119 which may be microprocessors, controllers, or any other suitable type of processors for processing computer executable instructions to control the operation of the electronic device. Alternatively, or in addition, the processor 1119 is any technology capable of executing logic or instructions, such as a hard-coded machine. In some examples, platform software comprising an operating system 1120 or any other suitable platform software is provided on the apparatus 1118 to enable application software 1121 to be executed on the device. In some examples, providing an AI workbench to enable efficient building and testing of ML projects via various pipelines as described herein is accomplished by software, hardware, and/or firmware.

In some examples, computer executable instructions are provided using any computer-readable media that is accessible by the computing apparatus 1118. Computer-readable media include, for example, computer storage media such as a memory 1122 and communications media. Computer storage media, such as a memory 1122, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 1122) is shown within the computing apparatus 1118, it will be appreciated by a person skilled in the art, that, in some examples, the storage is distributed or located remotely and accessed via a network or other communication link (e.g., using a communication interface 1123).

Further, in some examples, the computing apparatus 1118 comprises an input/output controller 1124 configured to output information to one or more output devices 1125, for example a display or a speaker, which are separate from or integral to the electronic device. Additionally, or alternatively, the input/output controller 1124 is configured to receive and process an input from one or more input devices 1126, for example, a keyboard, a microphone, or a touchpad. In one example, the output device 1125 also acts as the input device. An example of such a device is a touch sensitive display. The input/output controller 1124 may also output data to devices other than the output device, e.g., a locally connected printing device. In some examples, a user provides input to the input device(s) 1126 and/or receives output from the output device(s) 1125.

The functionality described herein can be performed, at least in part, by one or more hardware logic components. According to an embodiment, the computing apparatus 1118 is configured by the program code when executed by the processor 1119 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: automatically build a machine learning (ML) project environment on a server device using an environment configuration; configure a node cluster in the built ML project environment using a cluster configuration, wherein nodes of the node cluster are configured to execute workflows; provision network access and connectivity to the nodes of the node cluster using a network configuration associated with the built ML project environment; and deploy an application on the node cluster associated with an ML project workflow, whereby execution of the ML project workflow using at least one component of the server device is enabled automatically.

An example computerized method comprises automatically building a machine learning (ML) project environment using an environment configuration; configuring a node cluster in the built ML project environment on a server device using a cluster configuration, wherein nodes of the node cluster are configured to execute workflows; provisioning network access and connectivity to the nodes of the node cluster using a network configuration associated with the built ML project environment; and deploying an application on the node cluster associated with an ML project workflow, whereby execution of the ML project workflow using at least one component of the server device is enabled automatically.

One or more computer storage media having computer-executable instructions that, upon execution by a processor, case the processor to at least: automatically build a machine learning (ML) project environment on a server device using an environment configuration; configure a node cluster in the built ML project environment using a cluster configuration, wherein nodes of the node cluster are configured to execute workflows; provision network access and connectivity to the nodes of the node cluster using a network configuration associated with the built ML project environment; and deploy an application on the node cluster associated with an ML project workflow, whereby execution of the ML project workflow using at least one component of the server device is enabled automatically.

Alternatively, or in addition to the other examples described herein, examples include any combination of the following:
wherein automatically building the ML project environment using the environment configuration includes: generating a Network as a Service (NaaS) document that is specific to the ML project environment; an automatically configuring a network endpoint of the ML project environment, whereby the network endpoint enables connectivity to the node cluster of the ML project environment.
wherein automatically building the ML project environment using the environment configuration includes: validating a prerequisite associated with a gate agent process;
generating a manifest file configured for use during address allocation to nodes in the ML project environment; and initiating the gate agent process using the generated manifest file.
wherein configuring the node cluster in the built ML project environment using the cluster configuration includes: generating a cluster NaaS document for the node cluster, wherein the cluster NaaS document is configured for use with NaaS policies of the node cluster; and generating a control cluster pipeline of the node cluster, wherein the control cluster pipeline is configured to enable control of the node cluster within the ML project environment.
wherein deploying the application on the node cluster associated with the ML project workflow includes deploying an AI workbench application, wherein the AI workbench application is configured to: collect training data; engineer features using the collected training data; train an AI model using the engineered features and collected training data; and deploy the trained AI model to perform a model operation in response to input from another application.
wherein the AI workbench application is further configured to: monitor operations of the deployed AI model; collect feedback data based on the monitored operations; and adjust training of a next version of the AI model using the collected feedback data.
wherein the memory and the computer program code are configured to further cause the processor to: display a dashboard GUI for use by a user; receive model deployment instructions from the user via the displayed dashboard GUI; deploy an AI model based on the received model deployment instructions; verify operation of the deployed AI model; and respond to the received model deployment instructions to provide model access to the user.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for automatically building a machine learning (ML) project environment using an environment configuration; exemplary means for configuring a node cluster in the built ML project environment on a server device using a cluster configuration, wherein nodes of the node cluster are configured to execute workflows; exemplary means for provisioning network access and connectivity to the nodes of the node cluster using a network configuration associated with the built ML project environment; and exemplary means for deploying an application on the node cluster associated with an ML project workflow, whereby execution of the ML project workflow using at least one component of the server device is enabled automatically.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
automatically build a machine learning (ML) project environment on a server device using an environment configuration in response to receiving the environment configuration;
configure a node cluster in the built ML project environment using a cluster configuration, wherein nodes of the node cluster are configured to execute workflows;
provision network access and connectivity to the nodes of the node cluster using a network configuration associated with the built ML project environment; and
deploy an application on the node cluster associated with an ML project workflow, whereby execution of the ML project workflow using at least one component of the server device is enabled automatically.

2. The system of claim 1, wherein automatically building the ML project environment using the environment configuration includes:
generating a Network as a Service (NaaS) document that is specific to the ML project environment; and
automatically configuring a network endpoint of the ML project environment, whereby the network endpoint enables connectivity to the node cluster of the ML project environment.

3. The system of claim 1, wherein automatically building the ML project environment using the environment configuration includes:
validating a prerequisite associated with a gate agent process;
generating a manifest file configured for use during address allocation to nodes in the ML project environment; and
initiating the gate agent process using the generated manifest file.

4. The system of claim 3, wherein configuring the node cluster in the built ML project environment using the cluster configuration includes:
generating a cluster NaaS document for the node cluster, wherein the cluster NaaS document is configured for use with NaaS policies of the node cluster; and
generating a control cluster pipeline of the node cluster, wherein the control cluster pipeline is configured to enable control of the node cluster within the ML project environment.

5. The system of claim 1, wherein deploying the application on the node cluster associated with the ML project workflow includes deploying an AI workbench application, wherein the AI workbench application is configured to:
collect training data;
engineer features using the collected training data;
train an AI model using the engineered features and collected training data; and
deploy the trained AI model to perform a model operation in response to input from another application.

6. The system of claim 5, wherein the AI workbench application is further configured to:
monitor operations of the deployed AI model;
collect feedback data based on the monitored operations; and
adjust training of a next version of the AI model using the collected feedback data.

7. The system of claim 1, wherein the memory and the computer program code are configured to further cause the processor to:
display a dashboard GUI for use by a user;
receive model deployment instructions from the user via the displayed dashboard GUI;
deploy an AI model based on the received model deployment instructions;
verify operation of the deployed AI model; and
respond to the received model deployment instructions to provide model access to the user.

8. A computerized method comprising:
automatically building a machine learning (ML) project environment using an environment configuration in response to receiving the environment configuration;
configuring a node cluster in the built ML project environment on a server device using a cluster configuration, wherein nodes of the node cluster are configured to execute workflows;
provisioning network access and connectivity to the nodes of the node cluster using a network configuration associated with the built ML project environment; and
deploying an application on the node cluster associated with an ML project workflow, whereby execution of the ML project workflow using at least one component of the server device is enabled automatically.

9. The computerized method of claim 8, wherein automatically building the ML project environment using the environment configuration includes:
generating a Network as a Service (NaaS) document that is specific to the ML project environment; and
automatically configuring a network endpoint of the ML project environment, whereby the network endpoint enables connectivity to the node cluster of the ML project environment.

10. The computerized method of claim 8, wherein automatically building the ML project environment using the environment configuration includes:
validating a prerequisite associated with a gate agent process;
generating a manifest file configured for use during address allocation to nodes in the ML project environment; and
initiating the gate agent process using the generated manifest file.

11. The computerized method of claim 10, wherein configuring the node cluster in the built ML project environment using the cluster configuration includes:
generating a cluster NaaS document for the node cluster, wherein the cluster NaaS document is configured for use with NaaS policies of the node cluster; and
generating a control cluster pipeline of the node cluster, wherein the control cluster pipeline is configured to enable control of the node cluster within the ML project environment.

12. The computerized method of claim 8, wherein deploying the application on the node cluster associated with the ML project workflow includes deploying an AI workbench application, wherein the AI workbench application is configured to:
collect training data;
engineer features using the collected training data;
train an AI model using the engineered features and collected training data; and
deploy the trained AI model to perform a model operation in response to input from another application.

13. The computerized method of claim 12, wherein the AI workbench application is further configured to:
monitor operations of the deployed AI model;
collect feedback data based on the monitored operations; and
adjust training of a next version of the AI model using the collected feedback data.

14. The computerized method of claim 8, further comprising:
displaying a dashboard GUI for use by a user;
receiving model deployment instructions from the user via the displayed dashboard GUI;
deploying an AI model based on the received model deployment instructions;
verifying operation of the deployed AI model; and
responding to the received model deployment instructions to provide model access to the user.

15. A computer storage medium has computer-executable instructions that, upon execution by a processor, cause the processor to at least:
automatically build a machine learning (ML) project environment on a server device using an environment configuration in response to receiving the environment configuration;
configure a node cluster in the built ML project environment using a cluster configuration, wherein nodes of the node cluster are configured to execute workflows;
provision network access and connectivity to the nodes of the node cluster using a network configuration associated with the built ML project environment; and
deploy an application on the node cluster associated with an ML project workflow, whereby execution of the ML project workflow using at least one component of the server device is enabled automatically.

16. The computer storage medium of claim 15, wherein automatically building the ML project environment using the environment configuration includes:
generating a Network as a Service (NaaS) document that is specific to the ML project environment; and
automatically configuring a network endpoint of the ML project environment, whereby the network endpoint enables connectivity to the node cluster of the ML project environment.

17. The computer storage medium of claim 15, wherein automatically building the ML project environment using the environment configuration includes:
validating a prerequisite associated with a gate agent process;
generating a manifest file configured for use during address allocation to nodes in the ML project environment; and
initiating the gate agent process using the generated manifest file.

18. The computer storage medium of claim 17, wherein configuring the node cluster in the built ML project environment using the cluster configuration includes:
generating a cluster NaaS document for the node cluster, wherein the cluster NaaS document is configured for use with NaaS policies of the node cluster; and
generating a control cluster pipeline of the node cluster, wherein the control cluster pipeline is configured to enable control of the node cluster within the ML project environment.

19. The computer storage medium of claim 15, wherein deploying the application on the node cluster associated with the ML project workflow includes deploying an AI workbench application, wherein the AI workbench application is configured to:
collect training data;
engineer features using the collected training data;
train an AI model using the engineered features and collected training data; and
deploy the trained AI model to perform a model operation in response to input from another application.

20. The computer storage medium of claim 19, wherein the AI workbench application is further configured to:
monitor operations of the deployed AI model;
collect feedback data based on the monitored operations; and
adjust training of a next version of the AI model using the collected feedback data.
